(19) United States
(12) Patent Application Publication
(10) Pub. No.: US 2009/0024712 A1
(43) Pub. Date: Jan. 22, 2009

(54) METHOD AND SYSTEM FOR SUGGESTING AN EDITION OF PRODUCT SOFTWARE

(75) Inventors: Benjamin R. Weiss, Portola Valley, CA (US); James R. Del Favero, Redwood City, CA (US)

Correspondence Address: OSHA - LIANG L.L.P. (INTUIT), TWO HOUSTON CENTER, 909 FANNIN STREET, SUITE 3500, HOUSTON, TX, 77010, US

(73) Assignee: INTUIT INC., Mountain View, CA (US)

(21) Appl. No.: 11/779,103

(22) Filed: Jul. 17, 2007

(51) Int. Cl. G06F 15/16

(52) U.S. Cl. 709/207

(57) ABSTRACT

In general, the invention relates to a method for facilitating usage of a product. The method includes obtaining a usage level of a first edition of the product by the user, determining an inactivity level of the user based on the usage level, suggesting a second edition of the product to the user based on the inactivity level and facilitating use of the second edition of the product by the user, where the first edition of the product includes at least one additional feature as compared to the second edition of the product.

### BACKGROUND

In a general sense, product software may be used to perform a set of tasks desired by a user. Examples of product software include word processors, spreadsheets, databases, media players, business applications, and medical applications. Product software may be bundled with the operating system installed on a computer, installed separately, and/or accessed remotely (e.g., over a network connection).

Product software may also be associated with various features for performing the user's tasks. For example, media players may include features for visualization of music and creation of compact discs (CDs) and/or digital video discs (DVDs) from media files. In addition, the features may be tailored to the user's needs and/or capabilities. A more advanced user of the product software may require more advanced and/or complicated features than a basic user. As a result, product software may be released in various editions (or versions) to accommodate the needs of different types of users.

Users may have difficulty selecting a suitable edition of product software to purchase, which may result in the purchase of an edition that is not suited to the users' needs and/or capabilities. The ineffective selection of product software may also result in non-usage of one or more features of the software, or even a non-usage of the product software as a whole. Thus, users, manufacturers, and vendors of product software may benefit from mechanisms for recommending appropriate product software editions to users.

### SUMMARY

In general, in one aspect, the invention relates to a method for facilitating usage of a product. The method includes obtaining a usage level of a first edition of the product by the user, determining an inactivity level of the user based on the usage level, suggesting a second edition of the product to the user based on the inactivity level, and facilitating use of the second edition of the product by the user, where the first edition of the product comprises at least one additional feature as compared to the second edition of the product.

In general, in one aspect, the invention relates to a system for facilitating usage of a product. The system includes a usage module configured to obtain a usage level of a user of a first edition of a product, and determine an inactivity level of the first edition of the product by the user based on the usage level. The system further includes a recommendation engine configured to suggest a second edition of the product to the user based on the inactivity level, and facilitate use of the second edition of the product by the user, where the first edition of the product comprises at least one additional feature as compared to the second edition of the product.

In general, in one aspect, the invention relates to a computer readable medium comprising software instructions embodied therein for causing a computer system to: obtain a usage level of a first edition of the product by the user, determine an inactivity level of the user based on the usage level, suggest a second edition of the product to the user based on the inactivity level, and facilitate use of the second edition of the product by the user, where the first edition of the product comprises at least one additional feature as compared to the second edition of the product.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flow diagram in accordance with one or more embodiments of the invention.

FIG. 3 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system to suggest a product edition based on the use of the product by a user. Specifically, embodiments of the invention provide a method and system to suggest a lower product edition (e.g., an edition with fewer features, an edition designed for a novice user, an edition with a more graphical (or textual) interface, etc.) based on a user's non-usage of (i.e., inactivity level associated with) the product. The non-usage of the product may include non-usage of (or an inactivity level associated with) the entire product or of one or more features of the product.

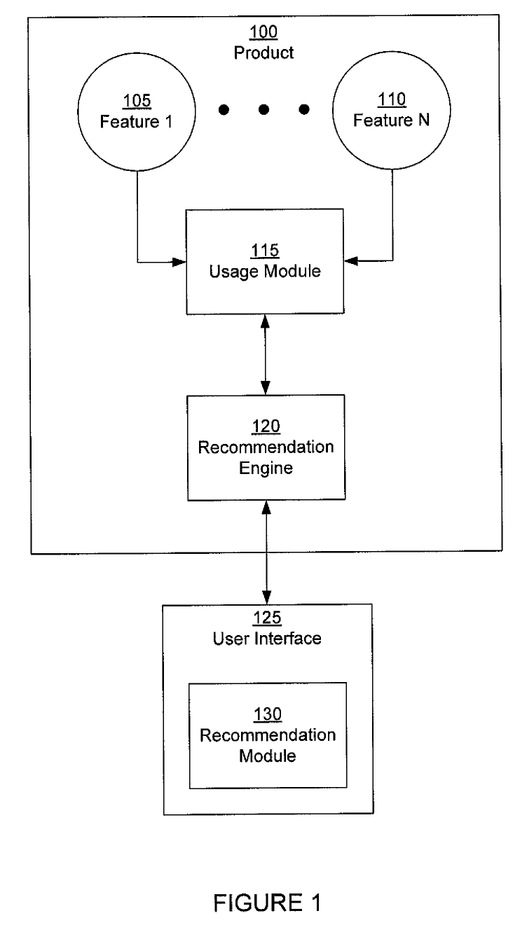

FIG. 1 shows a schematic diagram of a system in accordance with one or more embodiments of the invention. As shown in FIG. 1, the system includes a product (100) and a user interface (125). The product (100) additionally includes multiple features (e.g., feature 1 (105), feature n (110)), a usage module (115), and a recommendation engine (120). The product may be accessed and/or used by one or more users through the user interface (125).

In one or more embodiments of the invention, the product (100) is a software product, a service plan, or other product with the ability to track usage. Examples of the product (100) include: operating systems, integrated development environments (IDEs), industrial automation software, word processing software, accounting software, business software, medical software, computer games, cellular service plans, databases, and/or any other type of software-related product. In one or more embodiments of the invention, the product (100) may be used by the user to perform a set of tasks. For example, the user may use accounting software to create a budget, balance his/her checkbook, track his/her spending and investments, track phone usage, and perform other accounting-related functions. In addition, the product (100) may include multiple features (e.g., feature 1 (105), feature n (110)) to help the user perform the tasks. For example, accounting software may include a feature for generating charts and graphs of the user's finances, as well as another feature for downloading banking, credit card, and investment information into the product (100).

The product (100) may also be associated with one or more editions. Each edition of the product (100) includes one or more features (e.g., feature 1 (105), feature n (110)). The specific features (e.g., feature 1 (105), feature n (110)) included in a particular edition of the product (100) depend on the particular edition. In one embodiment of the invention, the higher edition of the product (100) may include more features (e.g., feature 1 (105), feature n (110)) and/or more advanced features, whereas a lower edition of the product (100) may have fewer and/or more basic features. For example, an accounting software product may include a basic edition and a deluxe edition. The basic edition may include functionality to track bank accounts, schedule payment reminders, and create a budget. The deluxe edition may include all the features of the basic edition, as well as features for finding tax deductions, planning for retirement, and tracking investment accounts.

Additionally, different editions of the product (100) may be implemented using different architectures. A web edition of the product (100) may run on one or more servers and be accessed using a web browser and/or a network connection. On the other hand, a client edition of the product may be installed locally on a computing system, which may include personal computers (PCs), mobile phones, personal digital assistants (PDAs), and other digital computing devices. Those skilled in the art will appreciate that different editions of the product (100) may include a different combination of features and/or architectures. For example, a higher edition of the product (100) may be released as both a client edition and a web edition, whereas a base edition of the product (100) may be released only as a web edition.

As mentioned above, the product (100) may be accessed and/or used by one or more users through a user interface (125). The user interface (125) may be a part of the product (100) or the user interface (125) may be a separate component. For example, a client edition of the product (100) may include a graphical user interface that may be accessed when the product (100) is installed and run on the user's computing system. However, a web edition of the product (100) may not be installed on the user's computing system. Instead, the product (100) may be executing on a server and the user may access the product (100) by using a web browser, which serves as a user interface (125) for the product (100).

In one or more embodiments of the invention, the usage module (115) determines a usage level and/or usage statistics of one or more users of the product (100). The usage module (115) may keep a record of the frequency and length of use of the product (100) by a particular user. The usage module (115) may additionally track the user's usage of different features (e.g., feature 1 (105), feature n (110)) of the product. For example, the usage module (115) may begin tracking usage of the product (100) upon installation of a client edition of the product (100) and/or subscription to a web edition of the product by the user. The usage module (115) may record each instance of use, the length of each use, and/or features used by the user. The usage module (115) may also apply statistical methods to determine patterns and trends in the user's usage of the product (100), as well as compare the patterns and trends with those of other users of the product (100).

In one or more embodiments of the invention, usage statistics obtained by the usage module (115) may be used by the recommendation engine (120) to suggest a different edition of the product (100) to the user. Specifically, the recommendation module (120) may suggest a lower edition of the product (100) to the user after a period of inactivity (e.g., a week, a month, three months, a year, or some other period of time) is detected by the usage module (115). The period of inactivity may correspond to a non-usage of the product (100) by the user. For example, the user may install accounting software on his system and access the accounting software a number of times after installation before discontinuing use of the accounting software for three months. On the other hand, the period of inactivity may be associated with the user's usage of a particular feature (e.g., feature 1 (105), feature n (110)) of the product (100). For example, a user of accounting software may use the budget managing feature frequently, but the user may never use the investment management feature because the user does not have any investment accounts and/or the investment management feature is too advanced or difficult for the user to use.

In one or more embodiments of the invention, the recommendation module (130) is included as part of the user interface (125). Once a period of inactivity is established by the usage module (115), the recommendation module (130) may suggest a lower edition of the product (100) to the user upon the user's next access to the product (100). The suggestion may then be presented in the form of an internal message or pop-up to the user upon logging into the product (100) if the product (100) is a web edition and/or starting an instance of the product (100) if the product (100) is a client edition. The recommendation module (130) may also communicate with the user through a variety of other external means. For example, the usage module (115) may track the user's usage and send the usage statistics to an external server (not shown). The usage module (115) may even exist on the external server and receive logs of the user's activity from the product (100). The recommendation engine (120) and recommendation module (130) may also run separately or together on one or more external server(s) and send suggestions to the user from the external server(s). For example, the recommendation module (130) may send the suggestion to the user through an email, text message, voicemail, instant message, and/or other communications medium.

Those skilled in the art will appreciate that an inactivity level of the user with respect to the product (100) may be established in various configurable manners. The inactivity level may correspond to non-usage or limited usage of one or more features of the product (100), or of the entire product (100), over a period of time. The period of time may also vary based on the nature of the product (100) and/or usage statistics by other users of the product (100). For example, if a majority of users tend to use a certain feature of the product (100) daily, the inactivity level for a particular user may be established within a week or two of observing the user's usage of that feature. However, if common usage of a feature of the product (100) is observed to be weekly or monthly, a period of non-usage or limited usage of the feature may take longer to establish for a particular user.

Those skilled in the art will also appreciate that the recommendation engine (120) may use various methods to suggest a lower edition of the product (100) to the user. For example, the recommendation engine (120) may suggest a base edition of the product (100) and/or web edition of the product (100) whenever any sort of inactivity is detected.

The base edition of the product (100) may include a basic set of features (e.g., feature 1 (105), feature n (110)) that are easier to use and grasp than the edition currently used by the user. On the other hand, the recommendation engine (120) may suggest the edition of the product (100) that is just below the user's current edition. For example, if four editions of the product (100) exist and the user currently has the third edition installed, the recommendation engine (120) may suggest the second edition of the product to the user if inactivity is detected by the usage module (115). As another option, the recommendation engine (120) may suggest an edition of the product (100) based on the user's usage of the features (e.g., feature 1 (105), feature n (110)) of the product (100). For example, if the user uses some, but not all, advanced features of the deluxe edition of the product (100), the recommendation engine (120) may suggest a lower edition of the product that includes most or all of the advanced features used by the user, but few or none of the advanced features that are unused.

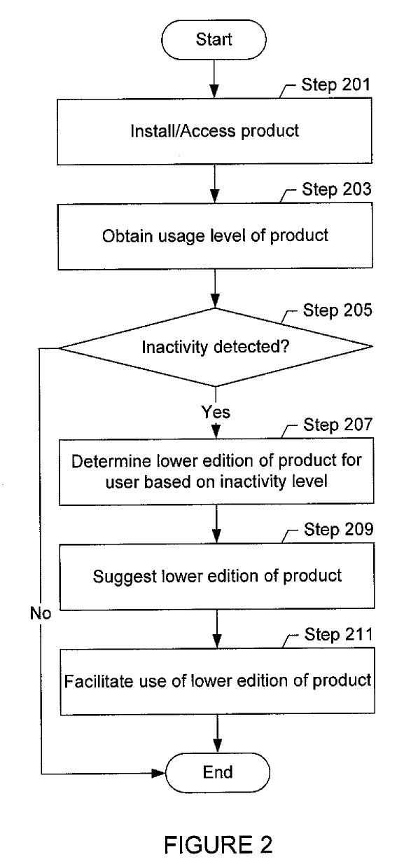

FIG. 2 shows a flow diagram of product edition recommendation in accordance with one or more embodiments of the invention. In one or more embodiments of the invention, one or more of the steps described below may be omitted, repeated, and/or performed in a different order. Accordingly, the specific arrangement of steps shown in FIG. 2 should not be construed as limiting the scope of the invention.

In Step 201, the product is installed, if the product is a client edition. Alternatively, if the product is a web edition, the user may simply subscribe to access the product, thereby enabling access to the product's features by the user through a web browser and network connection. Once the product is installed and/or the user's subscription to the product is activated, the user's usage level of the product is obtained (Step 203). As mentioned above, the usage level may include usage statistics such as frequency of use, length of use, and/or features used by the user.

The usage level may be analyzed to detect inactivity in the usage of the product by the user (Step 205). As mentioned above, the inactivity level may correspond to a non-usage of the entire product, a non-usage of one or more features of the product, or a combination thereof. The inactivity level may also correspond to limited usage of the entire product or one or more features of the product. The inactivity level may also be established over different lengths of time. For example, the user's inactivity may be determined after the user has not used one or more features of the product for a month. Alternatively, the inactivity level may be defined as non-usage of the entire product for three months. If inactivity is detected, a lower edition of the product is determined for the user based on the inactivity level (Step 207). For example, the lower edition may be based on a default suggestion, such as a base edition or the next lower edition of the product. On the other hand, the suggestion of the lower edition may be tailored to the user's usage of various features of the product. For example, the suggested lower edition may provide most or all of the features currently used by the user and/or few or none of the features not used by the user.

The lower edition of the product is then suggested to the user (Step 209) and use of the lower edition of the product is facilitated (Step 211). For example, the suggestion may include a link to allow the user to access, install, and/or purchase the lower edition. As mentioned above, the suggestion may be made by generating a pop-up in the user interface of the product, or by sending an internal message through the user interface or an external message using email, postal mail, text messaging, instant messaging, voicemail, and/or any other type of communications medium. In addition, the use of the lower edition may be associated with a variety of charges and/or credits. For example, the user's subscription fee to the product may be changed from a monthly fee corresponding to the higher edition of the product to a fee corresponding to the lower edition of the product once the user accepts the suggestion and begins using the lower edition. On the other hand, the user may be offered a refund of the higher edition's purchase price upon purchasing and/or installing the lower edition. The user may also be charged a suggestion fee that may be deducted by subtracting from any refunds and/or added to any fees the user may receive.

The functionality of the invention may be highlighted in various examples. However, the following examples are not intended to limit the scope of the invention. As a first example, a first user and a second user may purchase a third edition and a second edition of the product, respectively. The third edition may include a set of premium and/or advanced features of the product, and the second edition may include a set of deluxe and/or less advanced features of the product. Further, the inactivity level of the first user may be based on a non-usage of the entire third edition for two months, whereas the inactivity level of the second user may be based on a non-usage of the entire second edition for four months. As a result, the first user may be suggested to use a base edition of the product after not using the third edition for two months, while the second user may be suggested to use the base edition after not using the second edition for four months.

As a second example, a user may purchase a third edition of the product with features A, B, C, and D. Inactivity of the user may be defined as non-usage of one or more features of the third edition for two weeks. The product may also include a second edition with features A, B, and C, and a base edition with only feature A. Thus, if the user does not use features C and D for two weeks, the user may be suggested to use the second edition instead of the first edition because the second edition includes features A and B, which the user does use, whereas the first edition does not include feature B. Alternatively, the user may be given a listing of features to select from and be charged on a per-feature basis. Using the listing of features, the user may select features A and B and pay for each feature individually on top of a base price (e.g., the price of the base edition).

As a third example, a user may subscribe to a service plan with rate plans A and B. Rate plan A costs $200 for 200 hours/month of premium service during prime hours. Rate plan B costs $100 for 50 hours/month of standard service during prime hours. Inactivity of the user may be defined as less than 25 hours/month of usage during prime hours. If the user is paying for rate plan A and using the service less than 25 hours/month, then a suggestion is presented to the user to change to the less costly rate plan B.

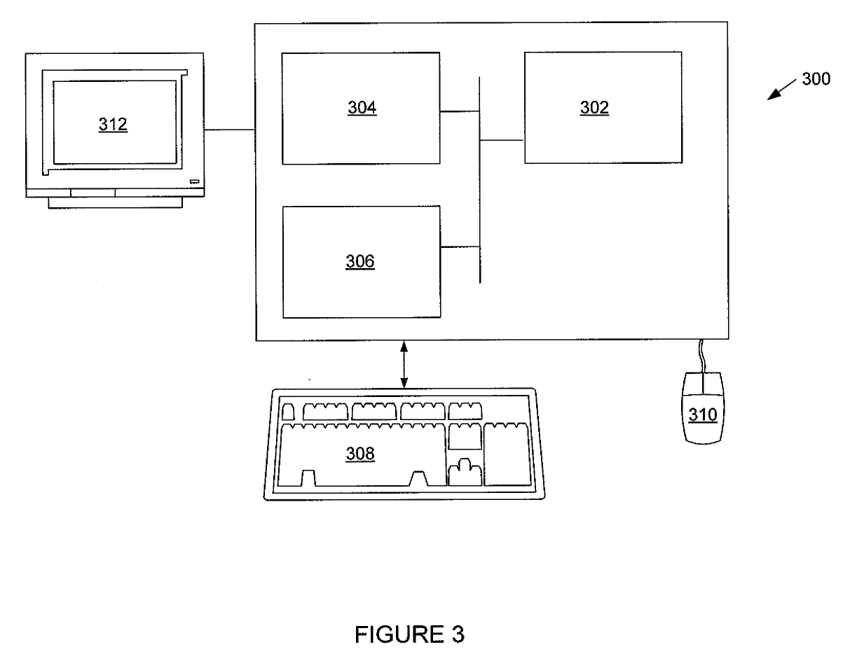

The invention may be implemented on virtually any type of computer regardless of the platform being used. For example, as shown in FIG. 3, a computer system (300) includes a processor (302), associated memory (304), a storage device (306), and numerous other elements and functionalities typical of today's computers (not shown). The computer (300) may also include input means, such as a keyboard (308) and a mouse (310), and output means, such as a monitor (312). The computer system (300) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (300) may be located at a remote location and connected to the other elements over a network. Further, the invention may be implemented on a distributed system having a plurality of nodes, where each portion of the invention (e.g., product, user interface, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for facilitating usage of a product, comprising:
obtaining a usage level of a first edition of the product by the user;
determining an inactivity level of the user based on the usage level;
suggesting a second edition of the product to the user based on the inactivity level; and
facilitating use of the second edition of the product by the user,
wherein the first edition of the product comprises at least one additional feature as compared to the second edition of the product.

2. The method of claim 1, wherein the inactivity level corresponds to non-usage of a feature of the first edition of the product.

3. The method of claim 2, wherein the second edition of the product fails to include the feature of the first edition.

4. The method of claim 1, wherein the inactivity level corresponds to a non-usage of the first edition of the product.

5. The method of claim 1, wherein the second edition of the product corresponds to a lower edition of the product.

6. The method of claim 1, wherein the first edition of the product is at least one selected from a group consisting of a client edition of the product and a web edition of the product, and wherein the second edition of the product is at least one selected from a group consisting of the client edition and the web edition of the product.

7. The method of claim 1, wherein the second edition of the product is suggested using at least one selected from a group consisting of a pop-up, an internal message, email, a text message, an instant message, voicemail, and postal mail.

8. The method of claim 1, wherein the inactivity level is determined over a period of time.

9. The method of claim 1, wherein the usage level comprises a usage level for each of a plurality of features in the first edition of the product.

10. A system for facilitating usage of a product, comprising:
a usage module configured to:
obtain a usage level of a user of a first edition of a product, and
determine an inactivity level of the first edition of the product by the user based on the usage level; and
a recommendation engine configured to:
suggest a second edition of the product to the user based on the inactivity level, and
facilitate use of the second edition of the product by the user,
wherein the first edition of the product comprises at least one additional feature as compared to the second edition of the product.

11. The system of claim 10, wherein the inactivity level corresponds to a non-usage of a feature.

12. The system of claim 11, wherein the second edition of the product fails to include the feature of the first edition.

13. The system of claim 10, wherein the inactivity level corresponds to a non-usage of the first edition.

14. The system of claim 10, wherein the second edition of the product corresponds to a base edition of the product.

15. The system of claim 10, wherein the first edition of the product is at least one selected from a group consisting of a client edition and a web edition, and wherein the second edition of the product is at least one selected from a group consisting of the client edition and the web edition.

16. The system of claim 10, wherein the second edition of the product is suggested using at least one selected from a group consisting of a pop-up, an internal message, email, a text message, an instant message, voicemail, and postal mail.

17. The system of claim 10, wherein the inactivity level is determined over a period of time.

18. The system of claim 17, wherein the usage level comprises a usage level for each of a plurality of features in the first edition of the product.

19. A computer readable medium comprising software instructions embodied therein for causing a computer system to:
obtain a usage level of a first edition of the product by the user;
determine an inactivity level of the user based on the usage level;
suggest a second edition of the product to the user based on the inactivity level; and
facilitate use of the second edition of the product by the user,
wherein the first edition of the product comprises at least one additional feature as compared to the second edition of the product.

20. The computer readable medium of claim 19, wherein the inactivity level corresponds to a non-usage of a feature of the first edition of the product.

21. The computer readable medium of claim 20, wherein the second edition of the product fails to include the feature of the first edition.

22. The computer readable medium of claim 19, wherein the inactivity level corresponds to a non-usage of the first edition of the product.

23. The computer readable medium of claim 19, wherein the second edition corresponds to a base edition of the product.

24. The computer readable medium of claim 19, wherein the first edition of the product is at least one selected from a group consisting of a client edition and a web edition, and wherein the second edition of the product is at least one selected from a group consisting of the client edition and the web edition.

25. The computer readable medium of claim 19, wherein the second edition of the product is suggested using at least one selected from a group consisting of a pop-up, an internal message, email, a text message, an instant message, voicemail, and postal mail.

26. The computer readable medium of claim 19, wherein the inactivity level is determined over a period of time.

27. The computer readable medium of claim 19, wherein the usage level comprises a usage level for each of a plurality of features of the first edition of the product.
